(19) United States
(12) Patent Application Publication
(10) Pub. No.: US 2010/0150035 A1
(43) Pub. Date: Jun. 17, 2010

(54) Method for Signaling Center Frequencies for WiMAX Repeaters

(76) Inventors: Zhifeng Tao, Allston, MA (US); Jinyun Zhang, Cambridge, MA (US); Sawa Kentaro, Fujisawa-Shi (JP); Toshiyuki Kuze, Kanagawa (JP)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/334,348

(22) Filed: Dec. 12, 2008

(51) Int. Cl. H04B 7/14; H04J 3/00; H04J 1/00

(52) U.S. Cl. 370/280; 370/315; 370/281

(57) ABSTRACT

A wireless network includes a base station (BS), a set of mobile stations (MS), and a set of repeaters. The channels between the BS and the repeater and between the repeater and the MS include a downlink (DL) and an uplink (UL). A BS specifies a first center frequency F2 for the channel between the BS and MS, and a second center frequency F1 for the channel between the repeater and the MS. The first center frequency F2 and the second center frequency are transmitted to the repeater and the MS in channel descriptor messages.

### FIELD OF THE INVENTION

This invention relates generally to wireless multi-user networks, and more particularly to frequency shift repeaters (FSR) in wireless-user networks.

### BACKGROUND OF THE INVENTION

Repeaters are often used to extend coverage for mobile stations (MS) at a fraction of the cost of installing additional base station (BS). The IEEE 802.16 standard, and the Worldwide Interoperability for Microwave Access (WiMax) standard based on 802.16 use microwave frequency bands, e.g., 2.5 GHz and 3.5 GHz, which do not propagate as well as conventional cellular technologies that operate in lower frequency bands. This is a problem for indoor wireless networks connected to outdoor wireless networks. Therefore, the range of the IEEE 802.16 networks needs to be extended for residential and enterprise applications. The embodiments provide changes to the current IEEE802. 16 standard to support repeaters operations.

### SUMMARY OF THE INVENTION

The invention specifies the signaling to support frequency shift repeater in wireless network. Specifically, a wireless network includes a base station (BS), a set of mobile stations (MS), and a set of repeaters. The channels between the BS and the repeater and between the repeater and the MS include a downlink (DL) and an uplink (UL). A BS specifies a first center frequency F2 for the channel between the BS and MS, and a second center frequency F1 for the channel between the repeater and the MS. The first center frequency F2 and the second center frequency are transmitted to the repeater and the MS in channel descriptor messages.

### BRIEF DESCRIPTION OF THE DRAWINGS

FIG. 1 is a block diagram of a wireless network with an in-band repeater according to embodiments of the invention;

FIG. 2 is a block diagram of a wireless network with an IEEE 802.16 frequency shift repeater (FSR) operating in TDD mode according to embodiments of the invention;

FIG. 3 is a block diagram of a wireless network with a IEEE 802.16 frequency shift repeater operating in FDD mode according to embodiments of the invention;

FIG. 4 is a block diagram with an IEEE802.16 in-band repeater with an isolation problem; and

FIG. 5 is a block diagram of an IEEE802. 16 frequency shift repeater with a digital filter according to embodiments of the invention.

### DETAILED DESCRIPTION OF THE PREFERRED EMBODIMENTS

Definitions

The following terms are defined and used accordingly herein.

Base Station (BS)

Equipment to provide wireless communication between subscriber equipment and a network infrastructure or network backbone.

Subscriber Station (SS)

A generalized equipment set to provide communication between subscriber equipment and the base station (BS).

Mobile Station (MS)

A wireless transceiver intended to be used while in motion or at unspecified locations. The MS is always a subscriber station (SS) unless specifically specified otherwise.

IEEE 802.16 Repeaters

A repeater extends the outdoor and indoor range of broadband IEEE 802.16 wireless networks. Repeaters include in-band repeaters and frequency shift repeaters (FSR). A frequency shift repeater can also be called frequency translation repeater, a frequency conversion repeater, or a frequency switching repeater.

In-Band Repeater

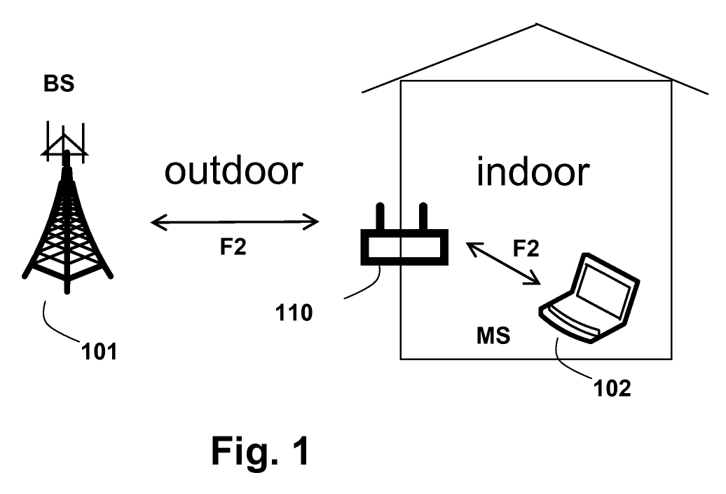

FIG. 1 shows a BS 101, a MS 102, and an in-band repeater 110 according to embodiments of the invention. The in-band repeater uses the same frequency band F2 to communicate with the BS and the MS. The frequency band is indicated by a center frequency, see below.

FSR Repeater

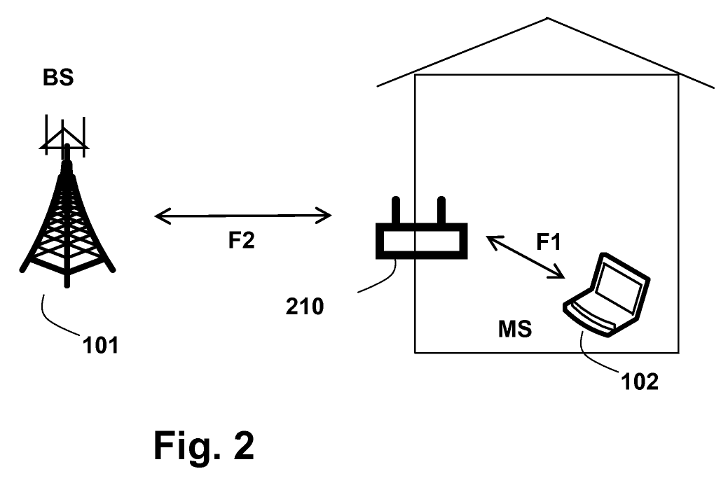

FIG. 2 shows the same network with a frequency shift repeater (FSR) 210 operating in time division duplex (TDD) mode. In this network, the BS and FSR use band F2 to communicate, and the FSR and MS use band F1, both for the downlink (DL) and the uplink (UL).

FSR Repeater with Frequency Shift

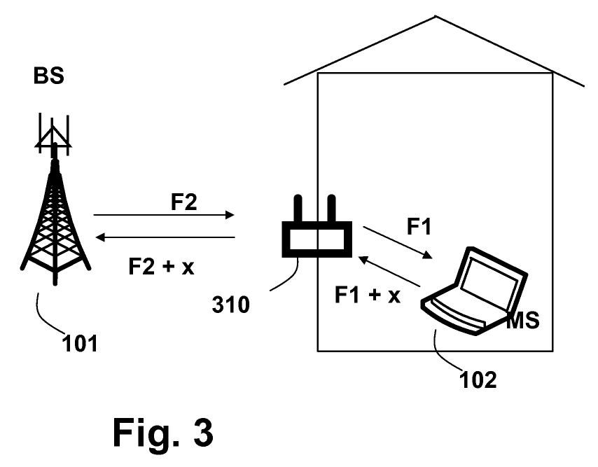

FIG. 3 shows the network with a FSR 310 operating in frequency division duplex (FDD) mode. More specifically, the DL from the BS to the FSR 310 and the uplink (UL) from the FSR to the BS use frequency bands F2 and F2+x, respectively. The DL from the FSR 310 and the uplink from the MS to the FSR use frequencies F1 and F1+x, respectively. The value x indicates a frequency offset in kHz.

Antenna Isolation

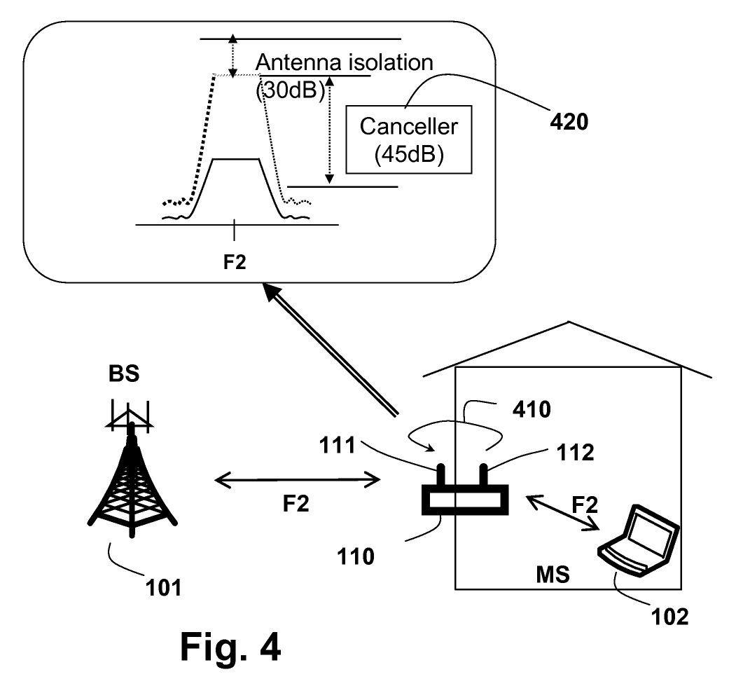

As shown in FIG. 4, the repeater 110 has a compact form factor. Therefore, it is difficult to obtain antenna isolation between the “donor” antenna 111 and the “service” (patch) antenna 112. This causes feedback 410. Therefore, the conventional in-band repeater uses a canceller to achieve sufficient antenna isolation. The canceller increases costs.

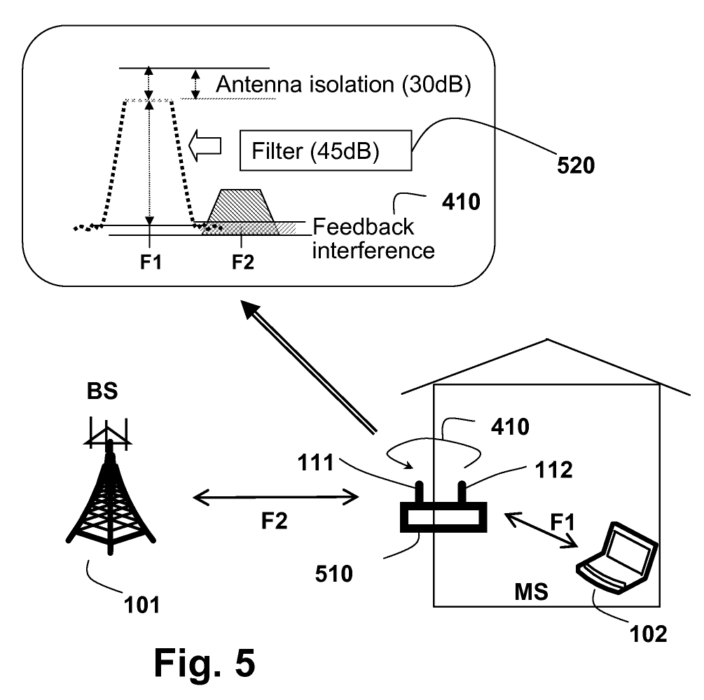

As shown in FIG. 5, a FSR 510 uses a digital bandpass filter 520 to effectively address the isolation problem between the donor and the service antennas 111-112.

Because the bandpass filter is included in the radio frequency (RF) module, this is a more cost-effective solution than the conventional in-band repeater with a canceller.

Scheme I

In the current IEEE 802.16 standard, the downlink channel descriptor (DCD) message, and the uplink channel descriptor (UCD) message are used to inform the MS of the frequency band to be used in the downlink and uplink. The format of the DCD and UCD messages are shown in Table 1 and Table 2, respectively. Note that frequency band is specified for the overall channel from the BS to the MS.

The table uses the conventional Type, Length, Value (TLV) format. The Type is a numeric code, which indicates the kind of field that this part of the message represents. The Length is the size of the value field (typically in bytes). The Value of the data for this part of the message.

TABLE 1
DCD message format

| | Size (L) | |
|---|---|---|
| Syntax (T) | (bit) | Notes (V) |
| DCD message format( ) { | | |
| Management message type = 1 | 8 | |
| Reserved | 8 | Shall be 0 |
| Configuration change count | 8 | |
| TLV encoded information for the overall | variable | TLV-specific |
| channel | | |
| Begin PHY-specific section { | | |
| For (i=1; i<=n; i++) { | | For each DL |
| | | burst profile 1 |
| | | to n |
| Downlink_burst_profile | variable | |
| } | | |
| } | | |
| } | | |

TABLE 2
UCD message format

| | Size | |
|---|---|---|
| Syntax | (bit) | Notes |
| UCD message format( ) { | | |
| Management message type = 0 | 8 | |
| Configuration change count | 8 | |
| Ranging backoff start | 8 | |
| Ranging backoff end | 8 | |
| Request backoff start | 8 | |
| Request backoff end | 8 | |
| TLV encoded information for the overall | variable | TLV-specific |
| channel | | |
| Begin PHY-specific section { | | |
| For (i=1; i<=n; i++) { | | For each DL |
| | | burst profile 1 |
| | | to n |
| Uplink_burst_profile | | PHY-specific |
| } | | |
| } | | |
| } | | |

One of the type-length values (TLVs) that can be in the DCD message is the central frequency of the band, as shown in Table 3.

TABLE 3
DL frequency TLV

| Name | Type (1 byte) | Length | Value (variable length) |
|---|---|---|---|
| Frequency | 12 | 4 | DL center frequency (kHz) |

One of the TLVs that can be up in UCD message is the central frequency, as shown in Table 4.

TABLE 4
UL frequency TLV

| Name | Type (1 byte) | Length | Value (variable length) |
|---|---|---|---|
| Frequency | 5 | 4 | UL center frequency (kHz) |

For the TDD network, the frequency band TLV in the DCD and UCD messages contain the same value, because the same frequency band is used for the uplink and the downlink. For example, the same frequency band F2 is used for both the uplink and the downlink on the wireless link between the BS and FSR.

However when the FSR is used, different MSs communicating with the BS can use different frequencies, depending on whether the MS is communicating with the BS via FSR, or not. Moreover, the BS does not know which associated MS is using the FSR, and which MS is not, because the FSR is transparent to the BS. That is, the BS does not know the frequency band used by the MS.

For the downlink, the following two options are available at the BS.

1) The BS does not include a central frequency TLV in the DCD message. Each MS independently determines the frequency band that the MS uses.

2) The BS does include the central frequency TLV in the DCD message. If the MS detects that the frequency band the MS is using is different than the frequency specified in the frequency TLV in the DCD message, then the MS knows that it is receiving from the FSR. In this case, the frequency value in the frequency TLV of DCD message is the center frequency of the frequency band used by the BS in the downlink. This is shown in the Table 5.

TABLE 5
DL frequency TLV

| Name | Type (1 byte) | Length | Value (variable length) |
|---|---|---|---|
| Frequency | 12 | 4 | DL center frequency of BS |
| | | | (kHz) |

For the uplink downlink, the following two options are available at the BS.

1) The BS does not include any center frequency TLV in the UCD message. Each MS determines the frequency band to use in uplink, based upon the center frequency the BS uses in the downlink. For TDD, these two frequency bands are the same.

2) The BS does include the center frequency TLV in the UCD message. Each MS does not use the center frequency value in the frequency TLV in the UCD message to determine the uplink center frequency the MS uses. Instead, the MS uses the same center frequency in the downlink and the uplink. In this case, the frequency value in the frequency TLV of the UCD message is the center frequency of BS. This is shown in the Table 6.

TABLE 6
UL frequency TLV

| Name | Type (1 byte) | Length | Value (variable length) |
|---|---|---|---|
| Frequency | 5 | 4 | UL center frequency of BS |
| | | | (kHz) |

For the FDD network, the frequency TLV in the DCD and the UCD messages contain different values, as different frequency bands are used for the uplink and the downlink.

In the FDD mode, the BS also does not know the frequency used by the MS in the uplink, because the FSR is transparent to the BS.

For the downlink, the following two options are available at the BS.

1) The BS does not include any frequency TLV in the DCD message. The MS independently determines the frequency band to use.

2) The BS includes the central frequency TLV in the DCD message. If the MS determines that this frequency is different than the frequency specified in the frequency TLV in the DCD message, then the MS knows that it is receiving from the FSR. In this case, the frequency value in the frequency TLV of the DCD message is the center frequency of BS. This is shown in the Table 5. This knowledge can facilitate handover and load balance operation at MS.

In this case, the BS can include a “frequency offset” TLV in the UCD message. Each MS uses the frequency offset value (x) contained in the “frequency offset” x TLV in the UCD message to determine the center frequency to use in the uplink. For instance, if the MS is using F1 as the center frequency in the downlink, then the MS uses (F1+x) as the center frequency in the uplink. This is shown in the Table 7.

TABLE 7
UL frequency offset TLV

| Name | Type (1 byte) | Length | Value (variable length) |
|---|---|---|---|
| Frequency | y | 4 | UL center frequency offset |
| | | | x (kHz) |

The type value “y” of this TLV is to be determined.

Scheme II

For a network with a simple FSR, the frequency band for the BS to FSR links and for the FST to NS links are usually predetermined by the operator of the network. That is, the frequency bands are fixed. Only a simple FSR follows this fixed approach considered hereafter.

To support FSR in the TDD network, the embodiments of the invention provide a new TLV called the FSR center frequency TLV. The FSR center frequency TLV included in the DCD and UCD messages indicates the center frequency that FSR uses to communicate with the MSs in the downlink and uplink, respectively.

A conventional MS cannot interpret the FSR center frequency TLV, and thus ignore this TLV.

In the downlink, the DCD message includes both the frequency TLV of the BS, and the frequency TLV of the FSR. A MS compliant with this new scheme can distinguish these two different TLVs. The MS can use the value contained in these two TLVs to determine whether it is directly communicating with the BS, or via the FSR.

The legacy MS does not understand this FSR center frequency TLV, and thus ignores this TLV. If MS understands this FSR center frequency TLV, and notices that the physical frequency it uses to synchronize with matches that indicated by FSR center frequency TLV, then the MS knows it is currently communicating directly with the FSR.

The format of FSR center frequency TLV is shown in the Table 8.

TABLE 8
DL FSR frequency TLV

| Name | Type | Length | Value (variable length) |
|---|---|---|---|
| Frequency | 158 | 4 | Center frequency (kHz) used by all |
| | | | frequency shift repeaters dependent on |
| | | | the BS to communicate with MSs in the |
| | | | downlink |

In the uplink, the UCD message includes both the frequency TLV of the BS, and the frequency TLV of the FSR. The MSs compliant with this scheme can distinguish these two different TLVs and use the value contained in these two TLVs to determine whether it is directly communicating with the BS or via an FSR. The format of the FSR center frequency TLV is shown in the Table 9.

TABLE 9
UL FSR frequency TLV

| Name | Type | Length | Value (variable length) |
|---|---|---|---|
| Frequency | 218 | 4 | Center frequency (kHz) used by all |
| | | | frequency shift repeaters dependent of the |
| | | | BS to communicate with MSs in the uplink |

Although the invention has been described with reference to certain preferred embodiments, it is to be understood that various other adaptations and modifications can be made within the spirit and scope of the invention. Therefore, it is the object of the append claims to cover all such variations and modifications as come within the true spirit and scope of the invention.

We claim:

1. A method for communicating in a wireless network including a base station (BS), a set of mobile stations (MS), and a set of repeaters, wherein channels between the BS and the repeater and between the repeater and the MS include a downlink (DL) and an uplink (UL), comprising:
specifying a first center frequency F2 for the channel between the BS and the MS in the downlink;
specifying a second center frequency F1 for the channel between the repeater and the MS in the downlink; and
transmitting the first center frequency F2 and the second center frequency to the repeater and the MS in channel descriptor messages.

2. The method of claim 1, wherein the network operates in time division duplex (TDD) mode.

3. The method of claim 1, wherein third and fourth center frequencies include a frequency offset x for the uplinks in the channels, and the network operates in frequency division duplex (FDD) mode.

4. The method of claim 1, wherein the repeater includes a digital bandpass filter to isolate a donor antenna from a service antenna of the repeater.

5. The method of claim 1, wherein the frequency offset is specified for the uplink and the down link of the channels.

6. The method of claim 1, wherein the channel descriptor messages include a downlink channel descriptor message and an uplink channel descriptor message.

7. The method of claim 1, further comprising:
determining, in the MS, whether the MS is communicating directly with the BS, or indirectly via the repeater, based on the first central frequency and the second central frequency the MS receives in the channel descriptor messages.

8. The method of claim 3, wherein the frequency offset x is specified in kHz.

9. The method of claim 1, wherein the network operates according to a IEEE 801.16 standard.

10. The method of claim 1, wherein the network operates according to a WiMAX standard.

11. The method of claim 1, wherein the first center frequency F2 and the second center frequency F1 are specified at the BS.
